(19) United States
(12) Patent Application Publication
(10) Pub. No.: US 2025/0386165 A1
(43) Pub. Date: Dec. 18, 2025

(54) INFORMATION PROCESSING APPARATUS, CONTROL METHOD, AND RECORDING MEDIUM

(71) Applicant: NEC Corporation, Minato-ku, Tokyo (JP)

(72) Inventor: Manao MACHIDA, Tokyo (JP)

(73) Assignee: NEC Corporation, Minato-ku, Tokyo (JP)

(21) Appl. No.: 18/875,815

(22) PCT Filed: Jul. 28, 2022
(86) PCT No.: PCT/JP2022/029060

§ 371 Date: Dec. 17, 2024

(51) Int. Cl. H04W 4/02; H04W 4/021

(52) U.S. Cl. CPC H04W 4/023; H04W 4/021

(57) ABSTRACT

An information processing apparatus includes: an estimating unit that estimates a communication range of a first mobile entity; an approximating unit that generates information representing a boundary of the communication range; and a generating unit that generates a region where a plurality of points, which are included in a first movement region that has been set in advance for the first mobile entity, and a communication range of the first mobile entity at each of the plurality of points overlap.

### TECHNICAL FIELD

The technical field of the present application relates to an information processing apparatus, a control method and a recording medium that maintain communication between mobile entities.

### BACKGROUND ART

In a multi-agent system in which a plurality of mobile entities (or “agents”) cooperate with each other, each mobile entity decides its own behavior based on information that has been observed by its own sensors and information about other mobile entities present in the vicinity. As one example, the mobile entities referred to here are mobile robots.

However, when robots that are engaged in local communication become separated by a certain distance or more, the transmission and reception of data will commonly no longer be possible, thereby causing an interruption to the communication.

As a related technology, Patent Document 1 discloses a method for detecting an interruption to communication between robots and moving the robots so that the communication is restored.

As another related technology, Non-Patent Document 1 discloses a method for maintaining communication by setting a limit on the distance between robots so as to keep the communication strength (a quantified value) of an entire multi-agent system at or above a certain level.

### LIST OF RELATED ART DOCUMENTS

### Patent Document

Patent document 1: Japanese Patent Laid-Open Publication No. 2017-62768

### Non Patent Document

Non-Patent Document 1: Cai, D., Wu, S., & Deng, J., “Distributed Global Connectivity Maintenance and Control of Multi-Robot Networks” IEEE Access, 5, 9398-9414, 2017.

### SUMMARY OF INVENTION

### Problems to be Solved by the Invention

In the method for restoring communication disclosed in Patent Document 1, or the method for maintaining communication disclosed in Non-Patent Document 1, communication between robots is always successful. It is also assumed that the distances between the robots are always known.

However, in an environment with poor visibility (such as an underwater environment), when the distance between a present robot and another robot is large, it is difficult to observe the position of the other robot using sensors alone.

In situations like this where the position of the other robot cannot be observed, the present robot and the other robot communicate with each other to acquire position information indicating the respective positions of the robots.

However, in environments such as underwater, communication will be unstable and may not necessarily succeed. This means that it is not always possible for robots to grasp each other's position. In addition, in a situation where communication may not always succeed, it is difficult to determine whether communication has been interrupted or whether communication may succeed.

One example reason why communication may or may not succeed when communication is unstable is that the distance over which communication can be performed may become shorter in all or some directions due to the environment changing. Note that the distance over which a robot can communicate will be uniform in all directions in a favorable communication environment, which means that the communication range can be represented by a sphere. However, if the environment changes, the communication range is no longer uniform in all directions, and the communication range can no longer be represented by a sphere.

An example object of present disclosure is to provide a framework for maintaining communication between mobile entities.

### Means for Solving the Problems

In order to achieve the example object described above, an information processing apparatus according to an example aspect of the present disclosure includes:
an estimating unit that estimates a communication range of a first mobile entity;
an approximating unit that generates information representing a boundary of the communication range; and
a generating unit that generates a region where a plurality of points, which are included in a first movement region that has been set in advance for the first mobile entity, and a communication range of the first mobile entity at each of the plurality of points overlap.

Also, in order to achieve the example object described above, a control method that is performed by a computer according to an example aspect of the present disclosure includes:
estimating a communication range of a first mobile entity;
generating information representing a boundary of the communication range; and
generating a region where a plurality of points, which are included in a first movement region that has been set in advance for the first mobile entity, and a communication range of the first mobile entity at each of the plurality of points overlap.

Furthermore, in order to achieve the example object described above, a computer-readable recording medium according to an example aspect of the present disclosure includes a program recorded on the computer-readable recording medium, the program including instructions that cause the computer to carry out:
estimating a communication range of a first mobile entity;
generating information representing a boundary of the communication range; and
generating a region where a plurality of points, which are included in a first movement region that has been set in advance for the first mobile entity, and a communication range of the first mobile entity at each of the plurality of points overlap.

### Advantageous Effects of the Invention

According to present disclosure, it is possible to maintain communication between mobile entities.

### BRIEF DESCRIPTION OF THE DRAWINGS

FIG. 1 is a diagram illustrating one example of an information processing apparatus according to a first example embodiment.

FIG. 2 is a diagram depicting an example system including a mobile entity according to the first example embodiment.

FIG. 3 is a diagram illustrating one example of approximating the communication range using a polygon.

FIG. 4 is a diagram illustrating one example of a constant communication region.

FIG. 5 is a diagram illustrating the first example.

FIG. 6 is a diagram illustrating the second example.

FIG. 7 is a diagram illustrating explaining a complementary convex polygon and a supplementary convex polygon.

FIG. 8 is a diagram illustrating explaining the overlapping of complementary convex polygons.

FIG. 9 is a diagram illustrating explaining the modified region and the constant communication region.

FIG. 10 is a diagram illustrating one example of the operations of the information processing apparatus according to the first example embodiment.

FIG. 11 is a diagram depicting one example of a system including mobile entities according to the second example embodiment.

FIG. 12 is a diagram illustrating optimization of the movement region using an incremental displacement region.

FIG. 13 is a diagram illustrating incremental displacement regions.

FIG. 14 is a diagram illustrating incremental displacement vectors.

FIG. 15 is a diagram illustrating the length of each side of the movement region.

FIG. 16 is a diagram illustrating a constraint that arises from the vector properties.

FIG. 17 is a diagram illustrating the generation of an incremental displacement region.

FIG. 18 is a diagram illustrating example operations of the information processing apparatus according to the second example embodiment.

FIG. 19 is a diagram illustrating approximation according to the third example embodiment.

FIG. 20 is a diagram illustrating the movement region and the constant communication region in the third example embodiment.

FIG. 21 is a diagram illustrating an example of a computer that realizes the first example embodiment, the first example, the second example, the second example embodiment and the third example embodiment.

### EXAMPLE EMBODIMENTS

Hereinafter, example embodiments will be described with reference to the attached drawings. Note that in the drawings described below, elements with the same or corresponding functions have been assigned the same reference numerals and duplicated description thereof may be omitted.

### First Example Embodiment

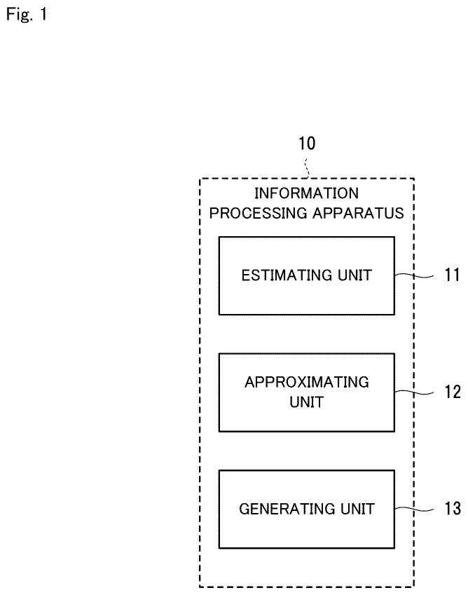

FIG. 1 is a diagram illustrating one example of an information processing apparatus according to a first example embodiment. An information processing apparatus 10 is mounted in an agent (a mobile entity) included in a multi-agent system.

### [Apparatus Configuration]

The information processing apparatus 10 executes a process of maintaining communication between mobile entities and a process of controlling movement of a mobile entity. The information processing apparatus 10 includes an estimating unit 11, an approximating unit 12, and a generating unit 13.

The estimating unit 11 estimates the communication range of a first mobile entity. The communication range is a range in which the mobile entity A (or “first mobile entity”) in question can communicate with another mobile entity B (or “second mobile entity”). In other words, it is sufficient for the “communication range” to be a range where communication between mobile entities A and B will probably succeed.

This is because depending on the environment in which the mobile entities A and B are located (as one example, an underwater environment), communication may not always succeed even when the mobile entity B is within the communication range of this mobile entity A.

The approximating unit 12 generates information representing the boundary of the communication range. As one example, for a two-dimensional range, the approximating unit 12 generates polygon information representing a polygon that approximates to the boundary line of the estimated communication range. By approximating the boundary line of the communication range using a polygon, it is possible to reduce the number of coordinates representing the boundary line of the communication range, which can reduce the amount of computation.

The generating unit 13 generates a region in which a plurality of points included in a first movement region, which is set in advance for the first mobile entity, overlap a communication region of the first mobile entity at each of such plurality of points. In more detail, the generating unit 13 uses a plurality of points included in a first movement region set in advance for the first mobile entity and polygons corresponding to the plurality of points to calculate a region in which the plurality of polygons overlap, thereby generating a constant communication region information representing a region in which the first mobile entity and a second mobile entity can communicate constantly to be used to set a second movement region of the second mobile entity.

The “movement region” is a region used to restrict the movement of a mobile entity. When a mobile entity is in this movement region, the mobile entity is capable of communicating with other mobile entities present in the constant communication region.

In this first example embodiment, by setting the movement region of the second mobile entity at this constant communication region, it will be possible to maintain communication between the first mobile entity and the second mobile entity so long as the first mobile entity is moving within the movement region.

### [System Configuration]

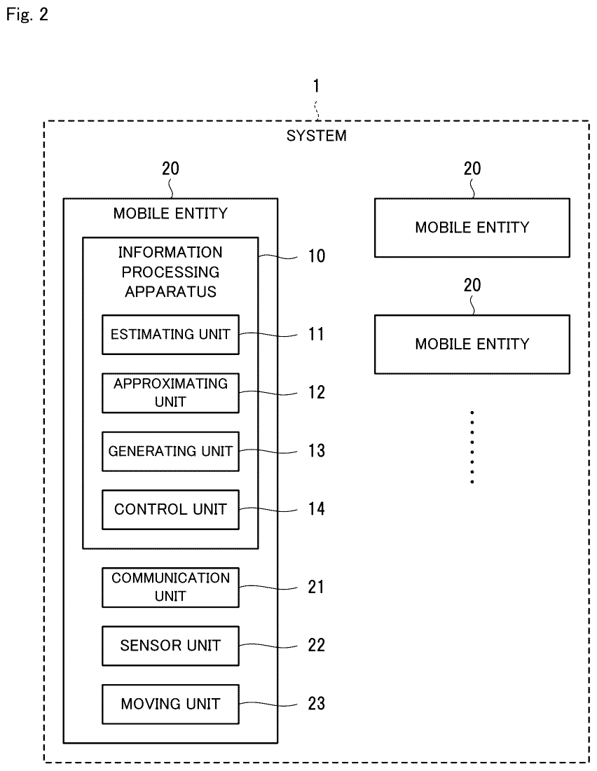

FIG. 2 is a diagram depicting an example system including a mobile entity according to the first example embodiment. The configuration of the information processing apparatus 10 according to the first example embodiment is described in detail below with reference to FIG. 2.

A system 1 is a multi-agent system. The system 1 includes a plurality of mobile entities 20 as agents.

The information processing apparatus 10 executes a process for maintaining one-way communication. One example of this process for maintaining one-way communication is a process for maintaining communication from the mobile entity A to the mobile entity B without necessarily maintaining communication from the mobile entity B to the mobile entity A.

The information processing apparatus 10 is an information processing apparatus, as examples a CPU (Central Processing Unit), a programmable device such as an FPGA (Field-Programmable Gate Array), a GPU (Graphics Processing Unit), or a circuit equipped with one or more of these.

As examples, each mobile entity 20 is a mobile robot, an unmanned guided vehicle, an autonomous vehicle, an autonomous flying object, or an autonomous vessel. The mobile entity 20 includes the information processing device 10, a communication unit 21, a sensor unit 22, and a moving unit 23.

The communication unit 21 communicates with the communication unit 21 of another mobile entity 20. The sensor unit 22 is a sensor that detects the state of the mobile entity 20, objects on a movement path, and the like. In more detail, the sensor unit 22 includes at least one of a radar, an ultrasonic sensor, an imaging device, a gyro, an encoder, and GPS (Global Positioning System).

The moving unit 23 is a device for moving the mobile entity 20. In more detail, when the mobile entity 20 is an unmanned guided vehicle, an electric vehicle, or the like, the moving unit 23 is a means used to move the vehicle, such as a motor, wheels (or crawlers) and a battery.

Next, the information processing apparatus will be described in detail.

The information processing apparatus 10 includes the estimating unit 11, the approximating unit 12, the generating unit 13, and a control unit 14.

The control unit 14 controls the moving unit 23 provided in the mobile entity 20. In more detail, the control unit 14 controls the moving unit 23 so that the mobile entity 20 does not leave the movement region.

The estimating unit 11 first obtains mobile entity position information indicating the current position (coordinates) of the mobile entity 20 from the sensor unit 22. Next, the estimating unit 11 estimates a plurality of coordinates indicating a boundary line of the communication range.

In more detail, the estimating unit 11 samples information about the surrounding water and seabed from various sensors or the like and generates a model of the surrounding conditions. This model of the surrounding conditions (space) is divided into an appropriate number of blocks, and the attenuation of sound waves between the divided blocks is calculated.

As one example, the attenuation between blocks can be calculated using the Schulkin & Marsh formula (see Schulkin M and Marsh H. W. “Sound absorption in seawater”, Journal of the Acoustical Society of America Vol. 34, 864-86 (1962)). This formula depends on the temperature, pressure, the pH, and the like of the ocean. Accordingly, the attenuation between blocks can be found by estimating the temperature, pressure, and pH of each block based on a model of the surroundings.

Finally, the attenuation to specific blocks centered on the mobile entity 20 is calculated by summing the attenuation between blocks. As one example, if sound travels from block 0, where the mobile entity 20 is located, through block 1 to block 2, and the attenuation between blocks 0 and 1 is 2 db (decibels) and the attenuation rate between blocks 1 and 2 is 3 db, the attenuation from block 0 to block 2 is 2 db+3 db=5 db. This operation is performed for each direction, and when the strength of the sound waves falls to a predetermined threshold or below, the point where this happens is set as the boundary of the communication range.

Next, the estimating unit 11 generates communication range information by associating the mobile entity position information with boundary line information that represents the boundary line of the estimated communication range using a plurality of coordinates and stores the communication range information in a storage unit provided in the information processing apparatus 10.

The approximating unit 12 first selects positions out of a plurality of positions that represent the boundary line of the estimated communication range based on an approximation rule which has been set in advance and generates polygon information that represents a polygon using coordinates that represent the selected positions.

As one example, a typical split & merge method (Nguyen, V., Gachter, S., Martinelli, A. et al. “A comparison of line extraction algorithms using 2D range data for indoor mobile robotics” Auton Robot 23, p 97-111 (2007), see https://doi.org/10.1007/s10514-007-9034-y) can be used as the approximation rule. This method can perform approximation to a polygon while keeping the approximation error within an appropriate distance d which is set as a threshold.

Next, the approximating unit 12 generates polygon information by associating the mobile entity position information with vertex information representing the coordinates of the vertices of the estimated polygon and stores the polygon information in a storage unit provided in the information processing apparatus 10.

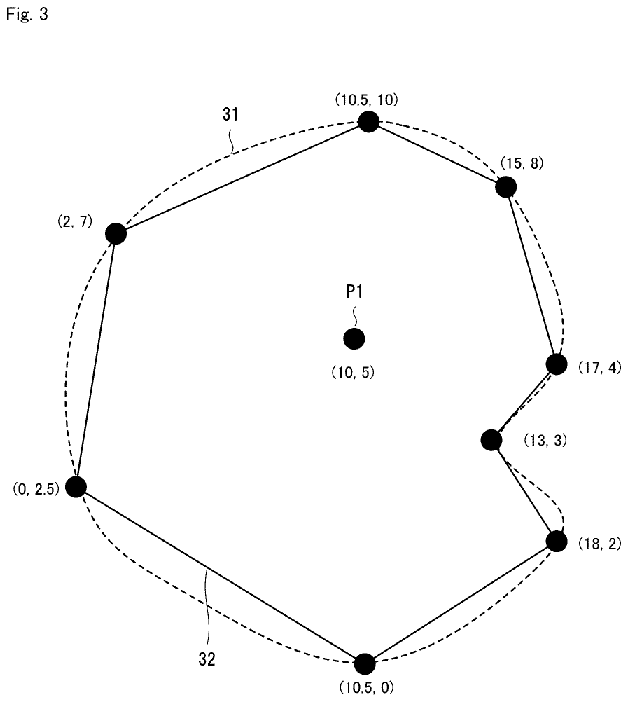

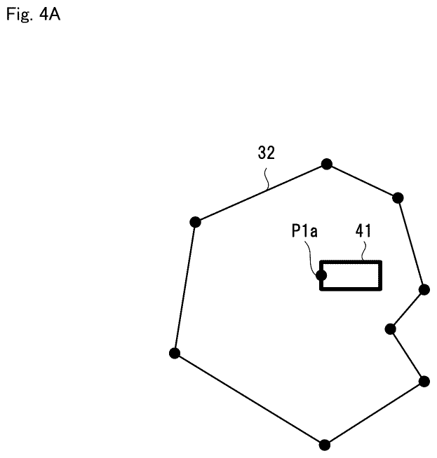

FIG. 3 is a diagram illustrating one example of approximating the communication range using a polygon. In the example in FIG. 3, a boundary line (a broken line) of a communication range 31 is indicated around the current position P1 of the mobile entity A. FIG. 3 also indicates a polygon 32 that approximates the shape of the communication range 31 (the broken line). The polygon 32 is an octagon represented by sides (solid lines) and vertices (black circles).

As one example, the vertex information is calculated using the coordinates of the current position P1 of the mobile entity 20 and the coordinates of the vertices of a polygon centered on the current position P1. In the example in FIG. 3, the vectors (−10,−2.5), (−8,2), (0.5,5), (5,3), (7,−1), (3,−2), (8,−3), and (0.5,−5) are calculated by subtracting (10,5) indicating the coordinates of the current position P1 of the mobile entity 20 from (0,2.5), (2,7), (10.5,10), (15,8), (17,4), (13,3), (18,2), and (10.5,0) indicating the coordinates of the vertices, with such vectors being arranged in a clockwise (or counterclockwise) direction to produce the vertex information.

The generating unit 13 first acquires the polygon information from the approximating unit 12. Next, the generating unit 13 uses polygons corresponding to points included in a movement region set in advance for the mobile entity 20 to calculate a region (or “constant communication region”) where all the polygons overlap. Each of these polygons represents the communication region when the mobile entity 20 is at a certain point (position).

The points included in the movement region referred to here may be every point in the movement region or may be only some of the points.

Next, the generating unit 13 generates the constant communication region information by associating the mobile entity position information with vertex information representing the coordinates of the vertices of the calculated constant communication region, and stores the generated constant communication region information in the storage unit.

Next, the generating unit 13 transmits the generated constant communication region information via the communication unit 21 to another mobile entity 20 (the “second mobile entity”). After this, the other mobile entity 20 that has received the constant communication region information and sets the constant communication region as the movement region.

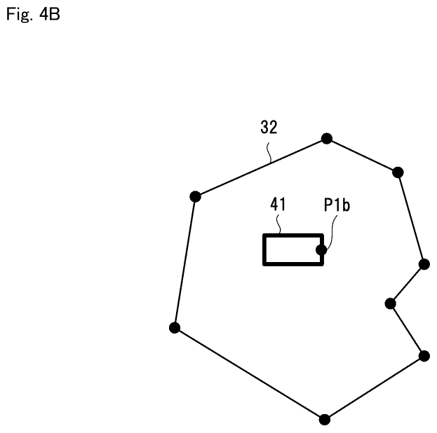

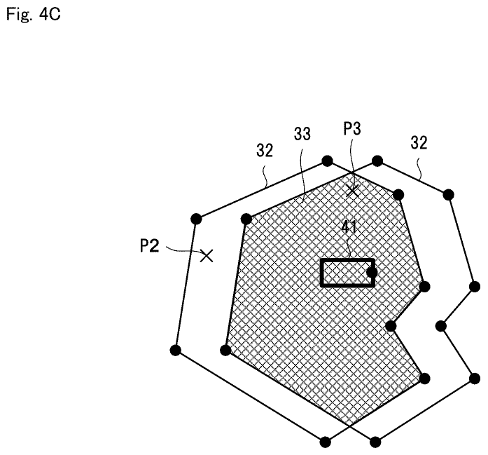

FIG. 4 is a diagram illustrating one example of a constant communication region. FIG. 4A depicts a polygon 32 approximating a constant communication range 31 which is centered on the coordinates P1a of the mobile entity 20, and a (rectangular) movement region 41 of the mobile entity 20.

FIG. 4B depicts a polygon 32 that approximates the communication range 31 centered on the position P1b of the mobile entity 20, and the (rectangular) movement region 41 of the mobile entity 20. Note that in both FIG. 4A and FIG. 4B, the movement region 41 of the mobile entity 20 is set at the same position.

FIG. 4C is a diagram in which FIG. 4A and FIG. 4B are superimposed.

As one example, a mobile entity 20 at position P2 (indicated by “X”) in FIG. 4C will be able to communicate with another mobile entity 20 when that mobile entity 20 is at position P1a indicated in FIG. 4A. However, when a mobile entity 20 is at position P1b as in FIG. 4B, it will not be possible to communicate with another mobile entity 20 at position P2 (indicated by “X”) in FIG. 4C.

Another mobile entity 20 at position P3 (also indicated by “X”) in FIG. 4C will be able to communicate with a mobile entity 20 regardless of whether such mobile entity 20 is at position P1a or position P1b.

The shaded region in FIG. 4C indicates the overlapping region of a polygon 32 that approximates to a communication range 31 centered on the position P1a and a polygon 32 that approximates to a communication range 31 centered on the position Pb1. As at the position P3 (indicated by “X”), another mobile entity 20 anywhere in the shaded region is able to communicate with the mobile entity 20 regardless of whether such mobile entity 20 is at position P1a or position P1b.

In this way, by using specified points (that is, positions of a mobile entity) in a movement region and polygons corresponding to each of such points to find a region where the polygons overlap, it is possible to know that another mobile entity 20 within the shaded region is able to communicate with the mobile entity 20 at any of the specified points.

By using every point (that is, position of the mobile entity) in a movement region and polygons corresponding to such points, as described above, it is possible for other mobile entities 20 to find a region in which such mobile entities 20 is able to communicate with a mobile entity 20 no matter where such mobile entity 20 is located within its movement region. This region is the constant communication region.

However, if a region where polygons corresponding to every point in the movement region overlap were calculated to calculate the constant communication region, this would result in a large amount of computation. For this reason, a method for calculating the constant communication region that is practical and has favorable computation efficiency will now be described.

### First Example

In a first example, a case will be described where each approximated polygon representing a communication range is a convex polygon.

The expression “convex polygon” refers to a shape where it is possible to select any two points within the convex polygon and any freely chosen point on a line segment connecting such two points will be included within the convex polygon. Also, for a polygon that is a convex polygon, the interior angle at every vertex of the convex polygon will be 180 degrees or less.

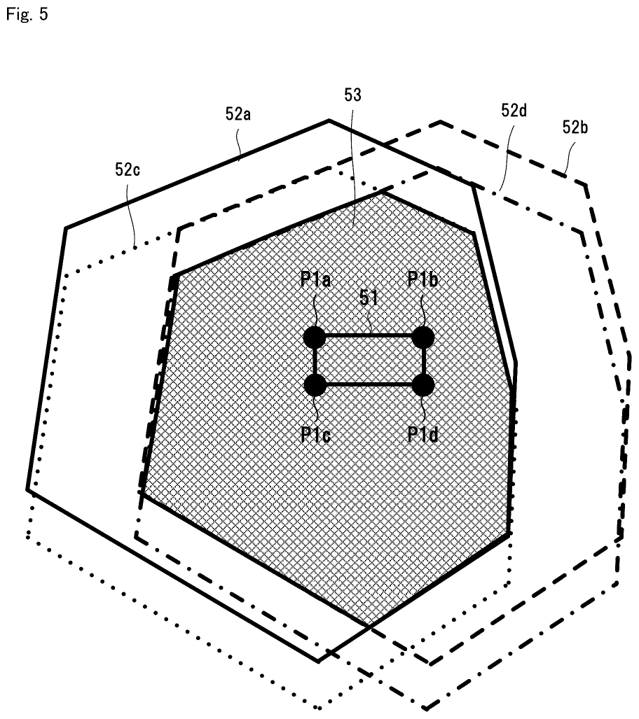

FIG. 5 is a diagram illustrating the first example. In the example in FIG. 5, convex polygons 52a, 52b, 52c, and 52d are set for the vertices (coordinates) P1a, P1b, P1c, and P1d respectively of a (rectangular) movement region 51, and a region 53 (indicated by shading) where all of the convex polygons 52a to 52d overlap is calculated. In other words, the region 53 is the constant communication region.

The constant communication region found here will match the overlapping region that would be produced if convex polygons were set for every point in the movement region. In other words, the precise constant communication region is calculated.

According to the first example, since the constant communication region is calculated using only the four vertices of the movement region 51 and not every point in the movement region 51, computation efficiency is improved compared to when the constant communication region is calculated using every point in the movement region 51.

Note that the shape of the movement region is not limited to a rectangle, and may be any freely chosen polygon.

### Second Example

In a second example, a case will be described in which the approximated polygon representing the communication range is not a convex polygon.

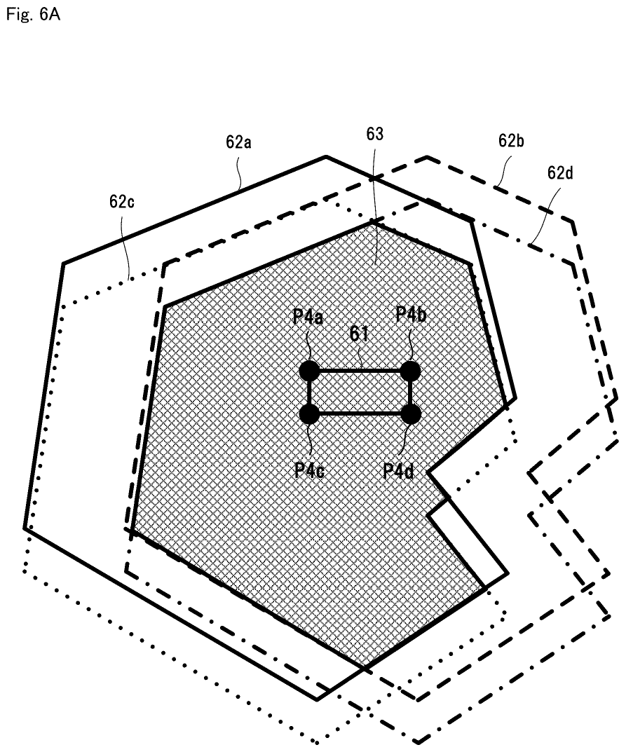

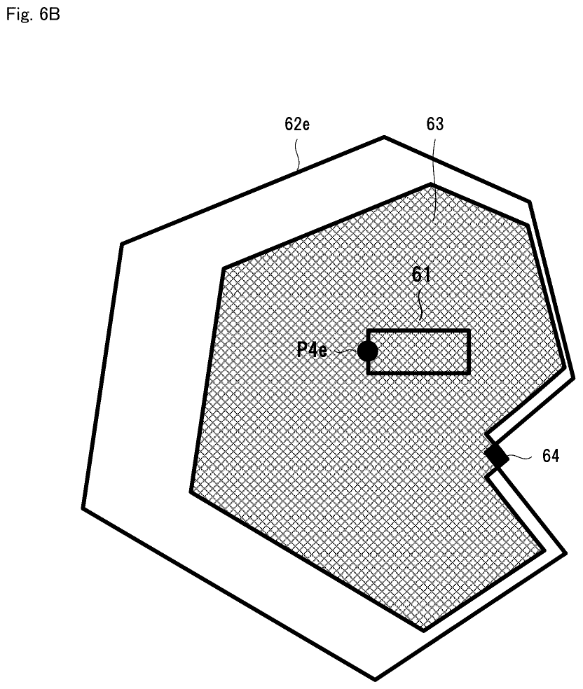

FIG. 6 is a diagram illustrating the second example. In the example in FIG. 6A, non-convex polygons 62a, 62b, 62c, and 62d are set for the vertices (coordinates) P4a, P4b, P4c, and P4d of a (rectangular) movement region 61, and a region 63 (indicated by shading) where all of the polygons 62a to 62d overlap is calculated.

However, in the example in FIG. 6B, when a mobile entity 20 has moved to a position P4e in the movement region 61, a region 64 will not be included in the region 63. This means that the region 63 is not the constant communication region.

For this reason, in the second example, the generating unit 13 first complements a polygon, which is not a convex polygon, with a supplementary convex polygon, to convert the polygon which is not a convex polygon into a convex polygon (hereinafter “complementary convex polygon”). In other words, a concave part of a polygon that is not a convex polygon is complemented with a supplementary convex polygon. However, when generating a complementary convex polygon, if there are a plurality of concave parts, a plurality of supplementary convex polygons is required.

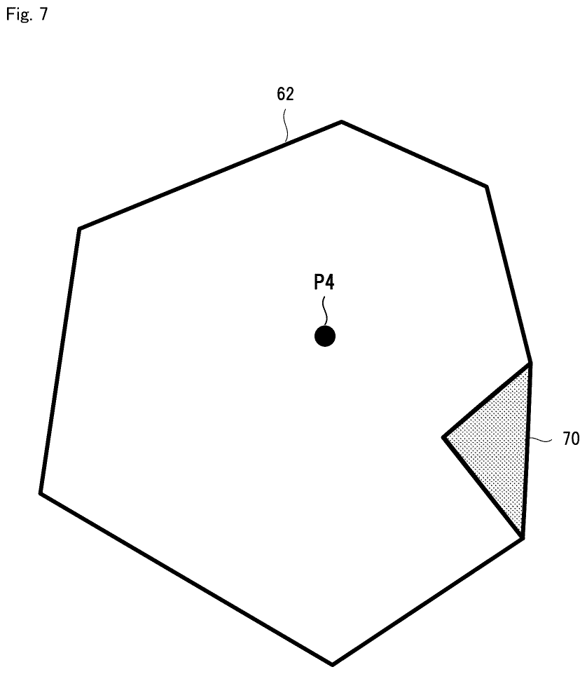

FIG. 7 is a diagram illustrating explaining a complementary convex polygon and a supplementary convex polygon. In the example in FIG. 7, a polygon 62 that is not a convex polygon is complemented with a supplementary convex polygon 70 to generate a complementary convex polygon.

A convex hull algorithm is used to generate this complementary convex polygon. A convex hull is the smallest convex polygon that contains every given point. This convex hull algorithm is used to find a convex hull that contains every vertex of a polygon that is not a convex polygon. The convex hull found in this way is a complementary convex polygon. One or a plurality of polygons that would be created when the original polygon is removed from the convex hull is a supplementary convex polygon.

Next, the generating unit 13 uses the complementary convex polygons corresponding to the points (coordinates) included in the movement region that has been set in advance for a mobile entity 20 to calculate a region (or “constant communication region”) where all of the complementary convex polygons overlap. Note that the points included in the movement region referred to here may be every point in the movement region or only some of the points.

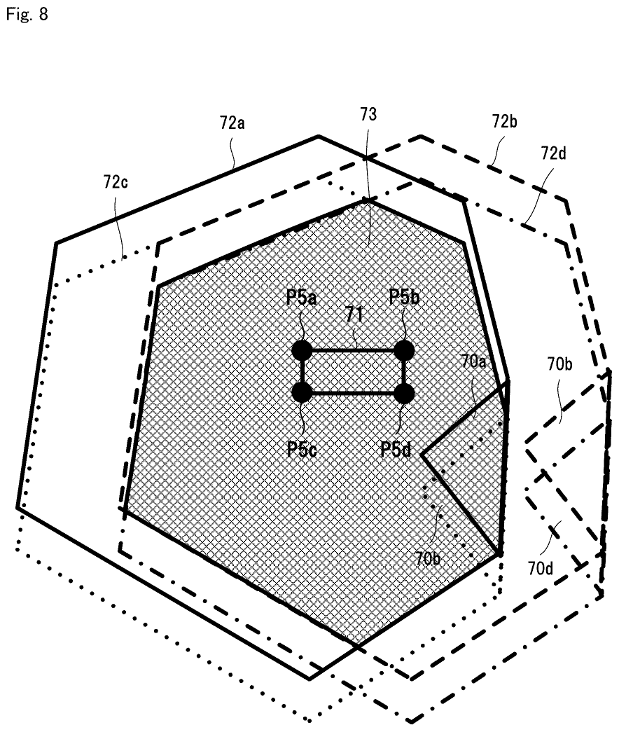

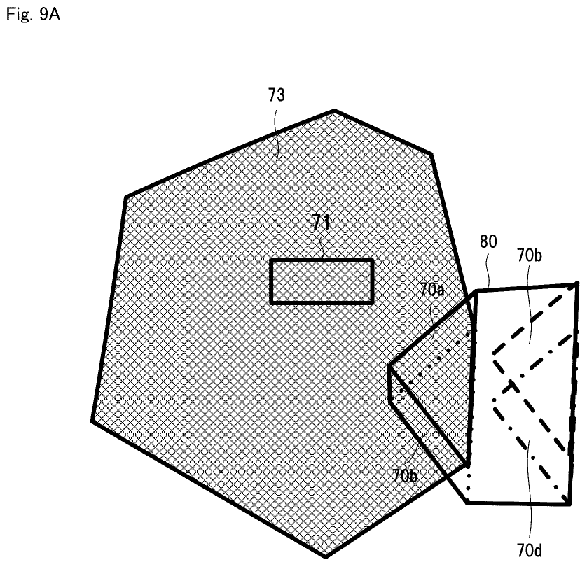

FIG. 8 is a diagram illustrating explaining the overlapping of complementary convex polygons. In the example in FIG. 8, complementary convex polygons 72a, 72b, 72c, and 72d are set for the vertices P5a, P5b, P5c, and P5d, respectively, in the (rectangular) movement region 71, and a region 73 (indicated by shading) where all of the complementary convex polygons 72a to 72d overlap is calculated.

In the example in FIG. 8, the complementary convex polygons 72a, 72b, 72c, and 72d are the results of complementing with the supplementary convex polygons 70a, 70b, 70c, and 70d, respectively.

Next, the generating unit 13 uses the vertices (coordinates) of each of the supplementary convex polygons included in all of the complementary convex polygons to generate a modified region that includes all of the supplementary convex polygons and is used to determine a constant communication region. This modified region represents a convex hull for the vertices of the supplementary convex polygons. The convex hull is the smallest figure that is a convex polygon that includes every point (coordinates) in the complementary convex polygons.

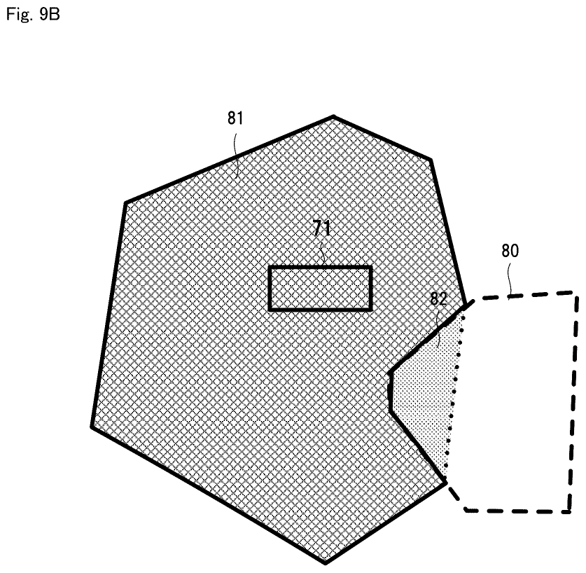

FIG. 9 is a diagram illustrating explaining the modified region and the constant communication region. In the example in FIG. 9A, the vertices of the supplementary convex polygons 70a, 70b, 70c, and 70d are used to generate a modified region 80 including the supplementary convex polygons 70a, 70b, 70c, and 70d.

Note that if there are a plurality of recesses in a polygon, that is, if there are a plurality of supplementary convex polygons, a modified region will be generated for each supplementary convex polygon.

In addition, if the movement region is not a convex polygon, the movement region is divided into a plurality of convex polygons, and a modified region is generated for each combination of the vertices of a divided convex polygon and a supplementary convex polygon.

When dividing a polygon that is not a convex polygon into a combination of convex polygons, as one example, a polygon triangulation algorithm may be used.

As one example, if a movement region is divided into a convex polygon A and a convex polygon B and two supplementary convex polygons a and b exist, modified regions are generated for each of the convex polygon A and the supplementary convex polygon a, the convex polygon A and the supplementary convex polygon b, the convex polygon B and the supplementary convex polygon a, and the convex polygon B and the supplementary convex polygon b.

Next, the generating unit 13 calculates the constant communication region by deleting regions that overlap a modified region from a region where all of the complementary convex polygons overlap. In the example of FIG. 9B, the generating unit 13 calculates a constant communication region 81 by deleting the region 82 of overlap between the region 73, where all of the complementary convex polygons overlap, and the modified region 80.

According to this second example, the constant communication region can be calculated even when the polygon approximating the communication range is not a convex polygon (or in other words, is a polygon including a concave).

The methods in the first and second examples can also realize the same processing even in three dimensions. That is, even if the approximating unit 12 approximates the communication range to a polyhedron and the movement region is also given as a polyhedron, the method in the first example can be used so long as the approximated polyhedron is a convex polyhedron (that is, convex polyhedrons centered on the respective vertices of the movement region polyhedron are considered and a region (that is, a solid) where they overlap is set as the constant communication region).

If the approximated polyhedron is not a convex polyhedron, in the same way as in the second example, a complementary convex polyhedron (that is, a complementary convex polygon that has been extended in three-dimensions) may be used to calculate the modified region (a solid).

### [Apparatus Operations]

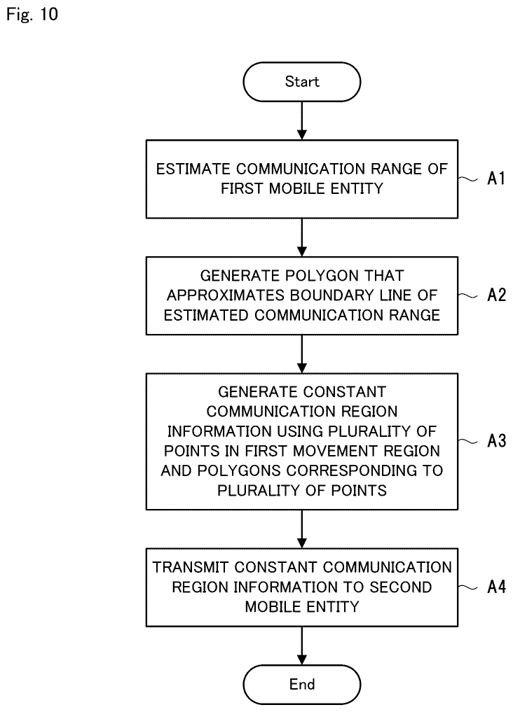

Next, the operations of the information processing apparatus according to the first example embodiment will be described with reference to FIG. 10. FIG. 10 is a diagram illustrating one example of the operations of the information processing apparatus according to the first example embodiment. The following description will refer as appropriate to the drawings. In this first example embodiment, an information processing method (or “control method”) is implemented by operating an information processing apparatus. Accordingly, a description of the control method according to the first example embodiment is replaced below with a description of the operations of the information processing apparatus.

As depicted in FIG. 10, first, the estimating unit 11 estimates the communication range of a target mobile entity 20 (or “first mobile entity”) (step A1).

Next, the approximating unit 12 generates polygon information representing a polygon approximating the boundary of the communication range that has been estimated (step A2). Note that in step A2, if the approximated polygon representing the communication range is not a convex polygon, the polygon information is generated by the method indicated in the second example.

After this, the generating unit 13 calculates an overlapping region of a plurality of polygons using a plurality of points included in a movement region (or “first movement region”) set in advance for the target mobile entity 20 and polygons corresponding to such plurality of points, and generates constant communication region information, which represents a region in which the target mobile entity and another mobile entity (or “second mobile entity”) can constantly communicate with each other and is to be set as a second movement region of the other mobile entity 20 (step A3).

Next, the generating unit 13 transmits the generated constant communication region information via the communication unit 21 to the other mobile entity (step A4).

After this, the other mobile entity 20 that has received the constant communication region information sets the constant communication region as its movement region.

### [Effects of First Example Embodiment]

As described above, according to the first example embodiment, the constant communication region can be calculated as described above using points in the movement region (that is, positions of a mobile entity) and polygons corresponding to each of such points.

In addition, according to the first example, the constant communication region is calculated using only some of the points in the movement region and not all of the points in the movement region, which makes the calculation more efficient than calculating the constant communication region using every point in the movement region.

According to the second example embodiment, the constant communication region can be calculated even if the polygon approximating the communication range is not a convex polygon (that is, the polygon is a polygon including a concave).

### [Program]

The program according to the first example embodiment, the first example and the second example may be a program that causes a computer to execute steps A1 to A4 shown in FIG. 10. By installing this program in a computer and executing the program, the information processing apparatus and the control method according to the first example embodiment can be realized. In this case, the processor of the computer performs processing to function as the estimating unit 11, the approximating unit 12, the generating unit 13, and the control unit 14.

Also, the program according to the first example embodiment, the first example and the second example may be executed by a computer system constructed by a plurality of computers. In this case, for example, each computer may function as any of the estimating unit 11, the approximating unit 12, the generating unit 13, and the control unit 14.

### Second Example Embodiment

In this second example embodiment, a method for optimizing the size of the movement region is described.

In this second example embodiment, maintaining two-way communication is considered. To do so, the movement regions of two mobile entities 20 are simultaneously considered.

The constant communication region generally becomes smaller as the movement region increases. In other words, there is a trade-off between the size of the movement region and the size of the constant communication region.

For this reason, a plurality of movement regions of different shapes are prepared as candidates, and the constant communication region is calculated for every movement region that has been prepared. Next, for each candidate movement region, the optimal movement region is selected using the size of a movement region and the size of the constant communication region corresponding to that movement region, based on an index representing the trade-off relationship.

As one example, this index is the sum of the area (or volume) of the movement region raised to the power of ½ and the area (or volume) of the constant communication region raised to the power of ½. By using such an index, it is possible to avoid candidates where one of the movement region and the constant communication region is extremely small and the other is extremely large, and to select a candidate where both values have large and well-balanced sizes.

However, it is not possible to exhaustively prepare movement regions with a plurality of different shapes. Even if it were possible to exhaustively prepare movement regions with a plurality of different shapes, it would be difficult to select the optimal movement region because of the enormous amount of computation that would be required.

For this reason, in the second example embodiment, a method for calculating an appropriate movement region with favorable computation efficiency is provided. In more detail, the movement region is gradually expanded so as to approach a movement region that is appropriate.

### [System Configuration]

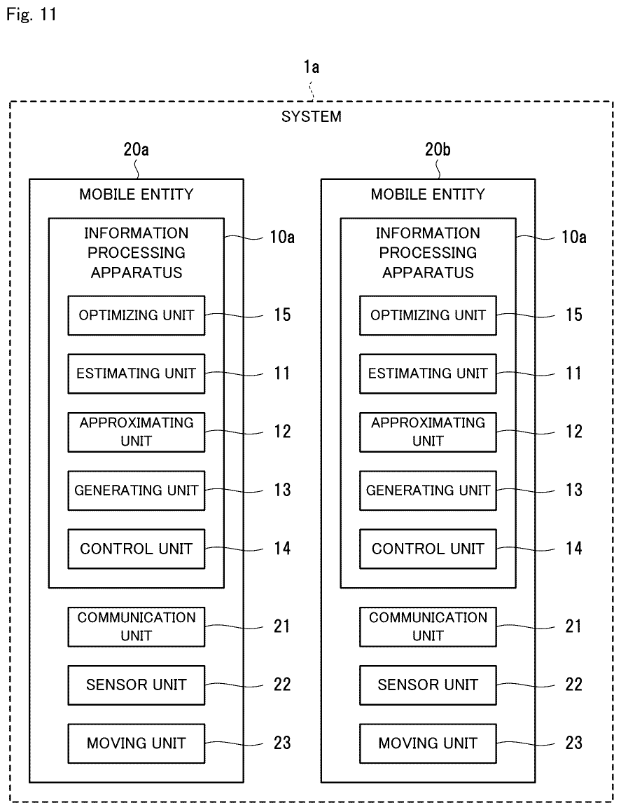

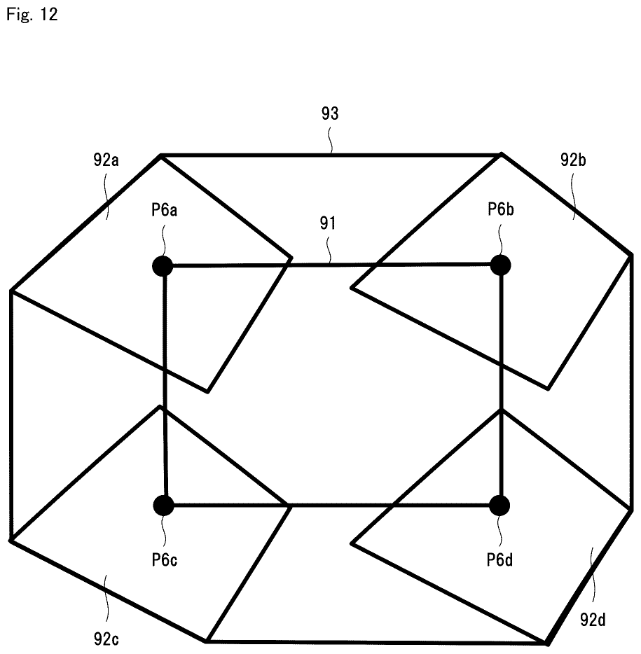

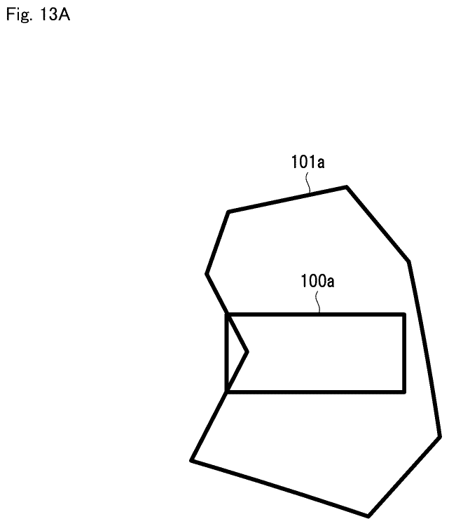

FIG. 11 is a diagram depicting one example of a system including mobile entities according to the second example embodiment. The configuration of an information processing apparatus 10a according to the second example embodiment will now be described in more detail with reference to FIG. 11.

The system 1a is a multi-agent system. The system 1a includes a plurality of mobile entities 20a as agents.

As examples, the mobile entities 20a and 20b are mobile robots, unmanned guided vehicles, autonomous vehicles, autonomous flying objects, or autonomous vessels. The mobile entities 20a and 20b each include the information processing apparatus 10a, the communication unit 21, the sensor unit 22, and the moving unit 23.

The information processing apparatus 10a includes the estimating unit 11, the approximating unit 12, the generating unit 13, the control unit 14, and an optimizing unit 15.

When operating, the optimizing unit 15 expands the current movement region set for the mobile entity 20a using an incremental displacement region to convert the movement region into an appropriate movement region.

In more detail, first, the optimizing unit 15 acquires a current first movement region set for the mobile entity 20a, a current first constant communication region corresponding to the current first movement region, a second movement region currently set for a mobile entity 20b, and a current second constant communication region corresponding to this current second movement region. Note that the initial movement regions are set at sufficiently small movement regions.

Next, the optimizing unit 15 generates an incremental displacement region using the current first movement region, the current first constant communication region, the current second movement region, and the current second constant communication region.

The incremental displacement region is a convex polygon and internally includes points (coordinates) that match points included in the movement region. The incremental displacement region information representing the incremental displacement region is information in which the points (coordinates) that match points included in the movement region and vertex information representing the vertices (coordinates) of the incremental displacement region are associated. A method for generating the incremental displacement region will be described later.

After this, the optimizing unit 15 of the mobile entity 20a uses the generated incremental displacement region to expand the current first movement region to generate a new first movement region and reduces the current first constant communication region to generate anew first constant communication region.

Next, the optimizing unit 15 of the mobile entity 20a uses the generated incremental displacement region to expand the current second movement region to generate a new second movement region and reduces the current second constant communication region to generate a new second constant communication region.

After this, the optimizing unit 15 determines whether the new first movement region and the new second movement region have been optimized and ends the optimization process if the regions have been optimized. If the regions have not been optimized, the optimizing unit 15 executes the optimization again.

To determine whether the first and second movement regions have been optimized, it is determined, based on an objective function described later, whether an increase in a function is equal to or below a threshold. If the increase is equal to or exceeds the threshold, it is highly likely that the movement regions are in the process of being expanded to more optimal regions. On the other hand, if the increase is equal to or below the threshold, it can be understood that the objective function value will hardly change even if the movement regions were expanded further and that the movement regions are already optimal.

A value set in advance is used as the threshold. Although the determination of whether a region is optimal can be made stricter by setting a smaller threshold, the longer the optimization will take to complete. The threshold is determined by experimentation or simulation with consideration to this trade-off.

Next, expansion of the movement region will be described.

FIG. 12 is a diagram illustrating optimization of the movement region using an incremental displacement region. In the example in FIG. 12, the (rectangular) movement region 91 is expanded to generate a movement region 93 using incremental displacement regions 92a, 92b, 92c, and 92d (polygons) that have been calculated for the vertices P6a, P6b, P6c, and P6d respectively of the movement region 91 and are centered on the vertices P6a, P6b, P6c, and P6d.

The movement region 93 represents a convex hull for the vertices of the incremental displacement regions 92a, 92b, 92c, and 92d. This convex hull is the smallest figure that is a convex polygon that includes all the points (coordinates) of the small displacement regions 92a, 92b, 92c, and 92d. The same processing can also be realized in three dimensions.

When the movement region is expanded using incremental displacement regions, the constant communication region will be reduced by an amount corresponding to the expansion of the movement region. In the example of FIG. 6, reference numeral 61 indicates an incremental displacement region. If the constant communication region is centered on the vertices P4a, P4b, P4c, and P4d of the incremental displacement region, reference numeral 63, where all of the shapes overlap, is the reduced constant communication region.

Incremental displacement regions will now be described.

In the second example embodiment, the achievement of two-way communication between the mobile entities 20a and 20b is considered. To achieve two-way communication, the movement region of the mobile entity 20a must be included in the constant communication region of the mobile entity 20b and the movement region of the mobile entity 20b must be included in the constant communication region of the mobile entity 20a.

Movement regions will be appropriate or inappropriate depending on the situations in which the mobile entities 20a and 20b are operated. Note that since the larger the movement region, the greater the degree of freedom for the mobile entities 20a and 20b, it is typically preferable for the movement regions to be large.

For this reason, an objective function for finding the optimal movement regions is expressed as Equation 1. In Equation 1, M_{A} represents the movement region of the mobile entity 20a, S(M_{A}) represents the area of this region, M_{B} represents the movement region of the mobile entity 20b, and S(M_{B}) represents the area of this region.

$$\sqrt{S ( {M}_{A} )} + \sqrt{S ( {M}_{B} )} \qquad [ Equation 1 ]$$

The reason the objective function is a sum of the respective areas raised to a power of ½ and not a simple sum of the areas is to make the sizes of the optimal movement regions of the mobile entities 20a and 20b as similar as possible.

This is also because when a simple sum of areas is used, a solution that limits the movement region of the mobile entity 20b to a single point (that is, the mobile entity 20b is assumed to not move at all) and maximizes only the movement region of the mobile entity 20a would be regarded as appropriate movement regions. Similar processing can also be realized in the case of volumes instead of areas.

In the second example embodiment, by making both the movement region of the mobile entity 20a and the movement region of the mobile entity 20b as large as possible, communication is achieved while increasing the freedom of movement of the two mobile entities 20a and 20b.

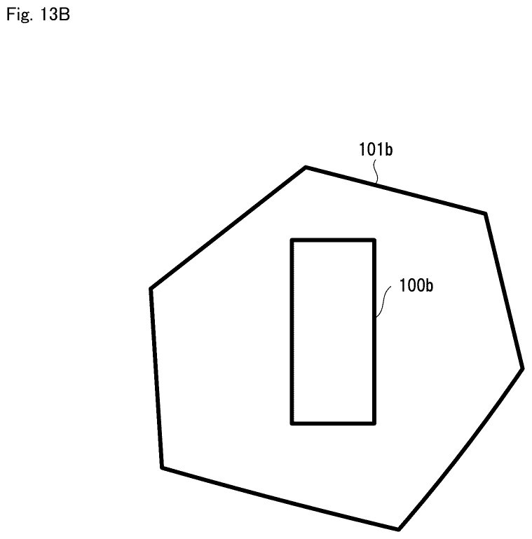

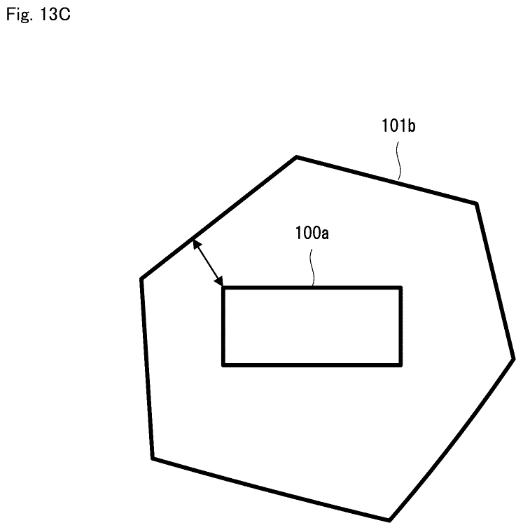

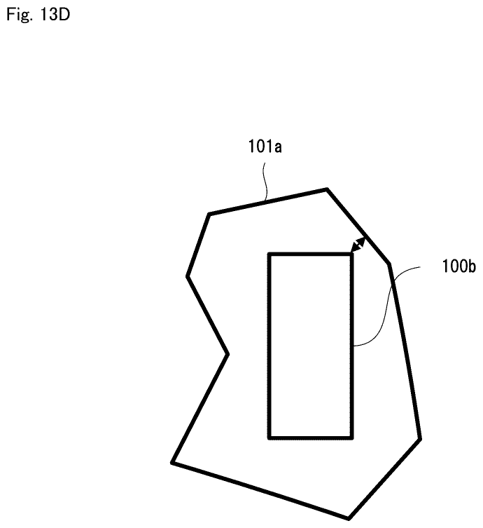

FIG. 13 is a diagram illustrating incremental displacement regions. FIG. 13A depicts the current movement region 100a and the constant communication region 101a of the mobile entity 20a. FIG. 13B depicts the current movement region 100b and the constant communication region 101b of the mobile entity 20b. Note that although FIGS. 13A and 13B depict the movement regions separately, in reality there will be an overlapping region between the movement regions.

FIG. 13C depicts the movement region 100a of the mobile entity 20a and the constant communication region 101b of the mobile entity 20b. FIG. 13D depicts the movement region 100b of the mobile entity 20b and the constant communication region 101a of the mobile entity 20a.

Next, an objective function for determining an optimal incremental displacement region from the current movement regions described above is indicated in Equation 2. The objective function for finding an incremental displacement region indicated in Equation 2 is expressed by the objective function indicated in Equation 1 and a constraint condition (or “penalty”).

$$\sqrt{S ( {M}_{A} )} + \sqrt{S ( {M}_{B} )} - α ( \frac{1}{d ( {M}_{A} , {C}_{B} ( {M}_{B} ) )} + \frac{1}{d ( {M}_{B} , {C}_{A} ( {M}_{A} ) )} ) \qquad [ Equation 2 ]$$

$$α ( \frac{1}{d ( {M}_{A} , {C}_{B} ( {M}_{B} ) )} + \frac{1}{d ( {M}_{B} , {C}_{A} ( {M}_{A} ) )} ) : constraint condition ( penalty )$$

In the penalty, C_{A}(M_{A}) represents the constant communication region when the movement region 100a of the mobile entity 20a is represented by the polygon M_{A}, and C_{B}(M_{B}) represents the constant communication region when the movable area of the mobile entity 20b is represented by the polygon M_{B}.

The penalty function d is a function that finds the smallest line segment out of line segments that connect the sides of the movement region and the sides of the constant communication region. The smallest line segment corresponds to the double-headed arrows in FIGS. 13C and 13D.

The penalty diverges to minus infinity when the movement region of one mobile entity 20a is about to protrude beyond the constant communication region of the other mobile entity 20b. For this reason, if an optimal result is found by the objective function of Equation 2 when calculating the incremental displacement region, the constraint of communication being maintained will automatically be achieved.

The penalty coefficient α is a tunable parameter that indicates how much importance is attached to the penalty.

Next, incremental displacement vectors relating to the objective function are determined. Each incremental displacement vector is expressed by a unit direction vector (that is, a vector with a length of 1) and a length. The incremental displacement vectors are vectors related to an increase in the area of the movement region of a mobile entity 20 and are outward vectors that are perpendicular to the respective sides of the movement region.

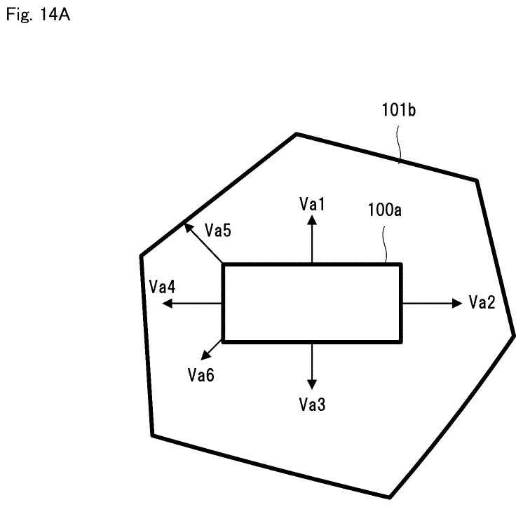

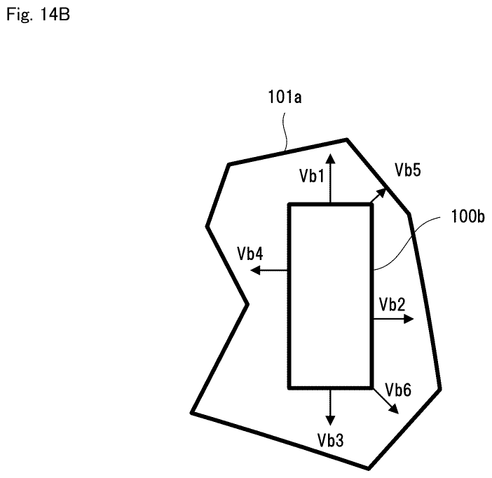

FIG. 14 is a diagram illustrating incremental displacement vectors. FIG. 14A depicts the incremental displacement vectors Va1, Va2, Va3, Va4, Va5, and Va6 for the movement region 100a in FIG. 13C. FIG. 14B depicts the incremental displacement vectors Vb1, Vb2, Vb3, Vb4, Vb5, and Vb6 for the movement region 100b in FIG. 13D.

The incremental displacement vectors Va1, Va2, Va3, Va4, Va5, and Va6 are expressed as indicated in Equation 3.

$$Va 1 , Va 2 , Va 3 , Va 4 , Va 5 , Va 6 = {a}_{1} \vec{{v}_{A 1}} , \\ {a}_{2} \vec{{v}_{A 2}} , {a}_{3} \vec{{v}_{A 3}} , {a}_{4} \vec{{v}_{A 4}} , {a}_{5} \vec{{v}_{A 5}} , {a}_{6} \vec{{v}_{A 6}} \qquad [ Equation 3 ]$$

$$\vec{{v}_{A 1}} , \vec{{v}_{A 2}} , \vec{{v}_{A 3}} , \vec{{v}_{A 4}} , \vec{{v}_{A 5}} , \vec{{v}_{A 6}} : unit direction vector$$

$${a}_{1} , {a}_{2} , {a}_{3} , {a}_{4} , {a}_{5} , {a}_{6} : length$$

The incremental displacement vectors Vb1, Vb2, Vb3, Vb4, Vb5, and Vb6 are expressed as indicated in Equation 4.

$$Vb 1 , Vb 2 , Vb 3 , Vb 4 , Vb 5 , Vb 6 = {b}_{1} \vec{{v}_{B 1}} , \\ {b}_{2} \vec{{v}_{B 2}} , {b}_{3} \vec{{v}_{B 3}} , {b}_{4} \vec{{v}_{B 4}} , {b}_{5} \vec{{v}_{B 5}} , {b}_{6} \vec{{v}_{B 6}} \qquad [ Equation 4 ]$$

$$\vec{{v}_{B 1}} , \vec{{v}_{B 2}} , \vec{{v}_{B 3}} , \vec{{v}_{B 4}} , \vec{{v}_{B 5}} , \vec{{v}_{B 6}} : unit direction vector$$

$${b}_{1} , {b}_{2} , {b}_{3} , {b}_{4} , {b}_{5} , {b}_{6} : length$$

The incremental displacement vectors of the movement region 100a of the mobile entity 20a are vectors that are related to an increase in area ΔS(M_{A}) of the movement region 100a of the mobile entity 20a. This increase in the area ΔS(M_{A}) can be approximated by Equation 5. The same also applies to volumes instead of areas.

$$Δ S ( {M}_{A} ) = {a}_{1} {l}_{A 1} + {a}_{2} {l}_{A 2} + {a}_{3} {l}_{A 3} + {a}_{4} {l}_{A 4} \qquad [ Equation 5 ]$$

However, when considering an increase in the volume of a polyhedron instead of an area, instead of calculating products of the length of each side and the lengths of vectors that represent the boundary of a polygon in Equation 5, products of the area of each face and the lengths of vectors that represent the boundaries of the polyhedron may be calculated.

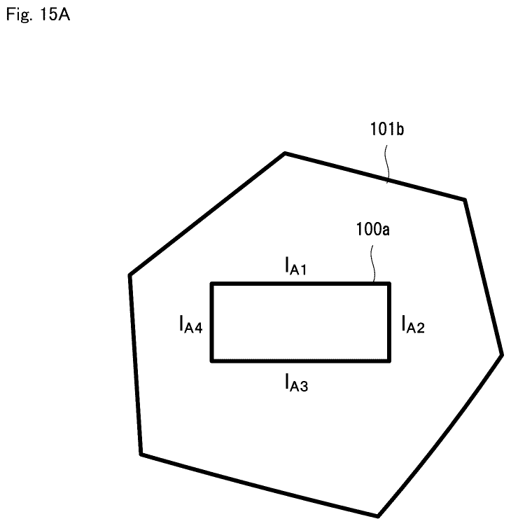

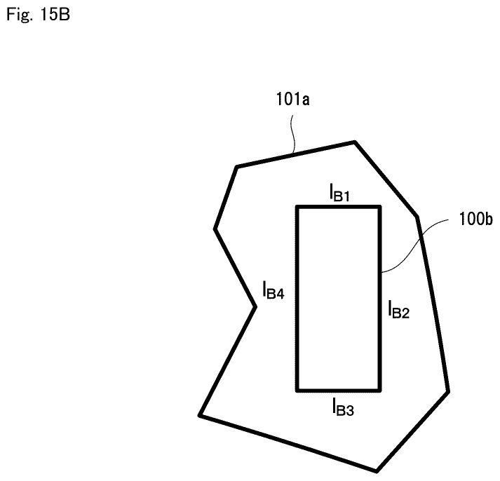

l_{A1}, l_{A2}, l_{A3}, and l_{A4} in Equation 5 represent the length of each side of the movement region 100a of the mobile entity 20a depicted in FIG. 15. FIG. 15 is a diagram illustrating the length of each side of the movement region.

The incremental displacement vectors of the movement region 100b of the mobile entity 20b are vectors that are related to an increase in area ΔS(M_{B}) of the movement region 100b of the mobile entity 20b. This increase in the area ΔS(M_{B}) can be approximated by Equation 6. The same also applies to volumes instead of areas.

L_{b1}, l_{B2}, l_{B3}, and l_{B4} in Equation 6 represent the length of each side of the movement region 100b of the mobile entity 20b in FIG. 15.

$$Δ S ( {M}_{B} ) = {b}_{1} {l}_{B 1} + {b}_{2} {l}_{B 2} + {b}_{3} {l}_{B 3} + {b}_{4} {l}_{B 4} \qquad [ Equation 6 ]$$

The incremental displacement vector Va5 is a vector related to a change in the distance between a side of the movement region 100a of the mobile entity 20a and a side of the constant communication region 101b of the mobile entity 20b. When the movement region 100a is expanded in the direction represented by the incremental displacement vector Va5, the distance between the sides becomes shorter.

The incremental displacement vector Vb6 is a vector related to a change in the distance between a side of the movement region 100b of the mobile entity 20b and the side of the constant communication region 101a of the mobile entity 20a. When the constant communication region 101a is reduced in the direction indicated by the incremental displacement vector Vb6, the distance between the sides becomes shorter.

The unit direction vector of the incremental displacement vector Va5 is an outward vector that is parallel to a line segment indicating the distance between the sides, and the unit direction vector of the incremental displacement vector Vb6 is a vector in the opposite direction to the unit direction vector of the incremental displacement vector Va5.

When the movement region 100a is expanded in the direction of the unit direction vector of the incremental displacement vector Va5, the constant communication region 101a is reduced by the same length in the same direction.

Accordingly, for the mobile entity 20a, the displacement Δd (M_{A}, C_{B}(M_{B})) in the distance between the sides can be approximated by Equation 7. Also, with regard to the mobile entity 20b, the displacement Δd (M_{B}, C_{A}(M_{A})) in the distance between the sides can be approximated by Equation 8.

$$Δ d ( {M}_{A} , {C}_{B} ( {M}_{B} ) ) = - {a}_{5} - {b}_{6} \qquad [ Equation 7 ]$$

$$Δ d ( {M}_{B} , {C}_{A} ( {M}_{A} ) ) = - {b}_{5} - {a}_{6} \qquad [ Equation 8 ]$$

Accordingly, the objective function after the incremental displacement (that is, after the movement region has been expanded by the incremental displacement) can be calculated using Equations 7 and 8. That is, it is sufficient to calculate the lengths a1, a2, a3, a4, a5, a6, b1, b2, b3, a4, a5, and a6 to maximize the objective function depicted in Equation 9. However, the constraints (i) and (ii) apply to the incremental displacement vectors.

$$\sqrt{S ( {M}_{A} ) + Δ S ( {M}_{A} )} + \sqrt{S ( {M}_{B} ) + Δ S ( {M}_{B} )} - α ( \frac{1}{d ( {M}_{A} , {C}_{B} ( {M}_{B} ) ) + Δ d ( {M}_{A} , {C}_{B} ( {M}_{B} ) )} + \frac{1}{d ( {M}_{B} , {C}_{A} ( {M}_{A} ) ) + Δ d ( {M}_{B} , {C}_{A} ( {M}_{A} ) )} ) \qquad [ Equation 9 ]$$

The approximations given in Equations 5 to 8 hold because the displacements are incremental. Constraint (i) that the displacement is incremental can be expressed by Equation 10.

$${\sum }_{i = 1}^{6} {a}_{i} + {\sum }_{i = 1}^{6} {b}_{i} \leq q ∧ {a}_{i} \geq 0 ∧ {b}_{i} \geq 0 \qquad [ Equation 10 ]$$

Since “q” in the Equation (10) is a sufficiently small value and the sum of the lengths of the vectors is equal to or less than q, the vectors are guaranteed to be incremental. Also, ai≥0∧bi≥0 guarantees that the length of the vector will not be a negative value.

Constraint (ii) that arises from the vector properties can be expressed by Equation 11.

$${a}_{i} \vec{{v}_{Ai}} \cdot \vec{{v}_{Aj}} \leq {a}_{j} ∧ {b}_{i} \vec{{v}_{Bi}} \cdot \vec{{v}_{Bj}} \leq {b}_{j} \qquad [ Equation 11 ]$$

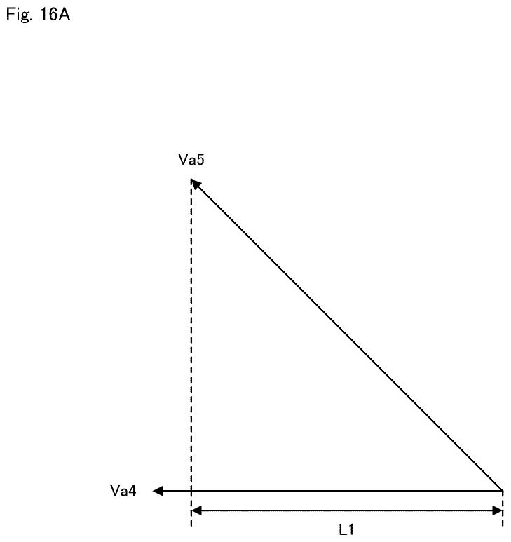

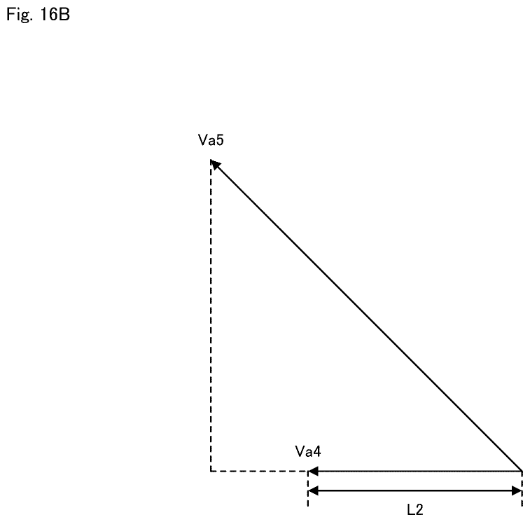

This constraint (ii) will now be described using FIG. 16. FIG. 16 is a diagram illustrating a constraint that arises from the vector properties. Since L1 indicated in FIG. 16A is represented by Equation 12, the constraint is satisfied.

$$L 1 = {a}_{5} \vec{{v}_{A 5}} \cdot \vec{{v}_{A 4}} \leq {a}_{4} \qquad [ Equation 12 ]$$

However, if this constraint is not satisfied, L1 will be displaced to L2 as depicted in FIG. 16B regardless of the incremental displacement in the lateral direction being determined as a4, which makes the constraint in Equation 11 necessary. Accordingly, the optimal incremental displacement vector can be calculated by solving an optimization problem using Equation 9 as the objective function and Equations 10 and 11 as the constraints.

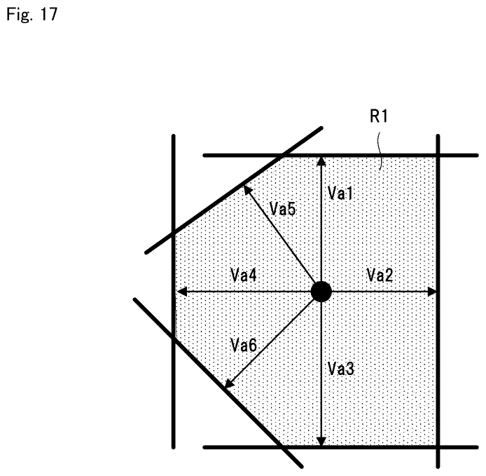

Next, an incremental displacement region is calculated from the incremental displacement vectors. FIG. 17 is a diagram illustrating the generation of an incremental displacement region. In the example in FIG. 17, incremental displacement vectors (arrows) are set to extend out from the same point (marked as “●”), line segments (solid lines) that are tangential to and perpendicular to the incremental displacement vectors are drawn, and a region R1 (or “point region”) surrounded by these line segments is set as the incremental displacement region.

### [Apparatus Operations]

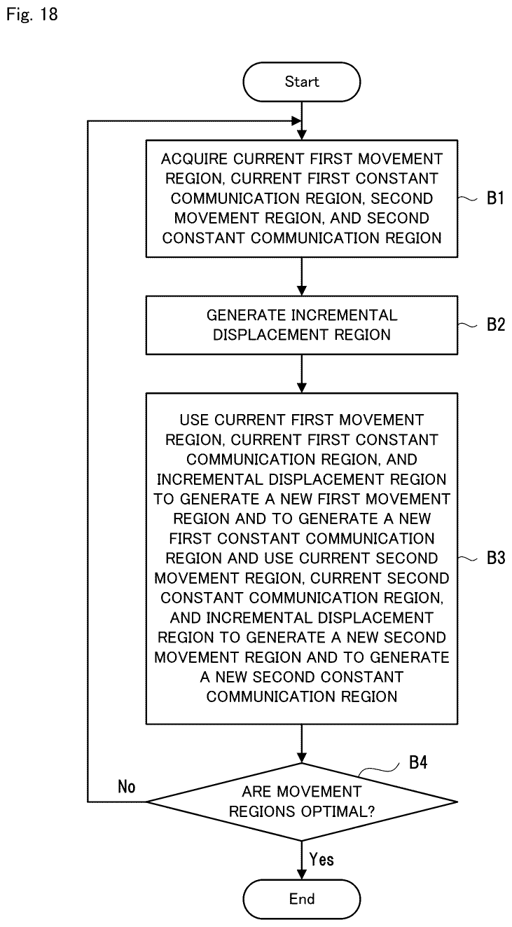

Next, the operations of the information processing apparatus according to the second example embodiment will be described with reference to FIG. 18. FIG. 18 is a diagram illustrating example operations of the information processing apparatus according to the second example embodiment. The following description will make reference to the drawings as appropriate. Also, in this second example embodiment, an information processing method (or “control method”) is implemented by operating an information processing apparatus. Accordingly, a description of the control method according to the first example embodiment is replaced below with a description of the operation of the information processing apparatus.

As depicted in FIG. 18, first, the optimizing unit 15 acquires a first movement region set for the current mobile entity 20a, a current first constant communication region corresponding to the current first movement region, a second movement region set for the current mobile entity 20b, and a current second constant communication region corresponding to the current second movement region (step B1). Note that the initial movement regions are set at sufficiently small movement regions.

Next, the optimizing unit 15 generates an incremental displacement region using the current first movement region, the current first constant communication region, the current second movement region, and the current second constant communication region (step B2).

After this, the optimizing unit 15 uses the current first movement region, the current first constant communication region, and the generated incremental displacement region to expand the current first movement region to generate a new first movement region and to reduce the current first constant communication region to generate a new first constant communication region (step B3).

In addition, in step A3, the optimizing unit 15 uses the current second movement region, the current second constant communication region, and the generated incremental displacement region to expand the current second movement region to generate a new second movement region and to reduce the current second constant communication region to generate a new second constant communication region.

Next, if the new first movement region and the new second movement region have been optimized (step B4: Yes), the optimizing unit 15 ends the optimization process. If these regions have not been optimized (step B4: No), the optimizing unit 15 proceeds to step B1.

The processing in steps B1 to B4 described above are repeatedly executed to finally determine appropriate movement regions.

### [Effects of Second Example Embodiment]

As described above, according to the second example embodiment, appropriate movement regions can be calculated with high computation efficiency.

### [Program]

The program according to the second example embodiment, the first example and the second example may be a program that causes a computer to execute steps B1 to B4 shown in FIG. 18. By installing this program in a computer and executing the program, the information processing apparatus and the control method according to the second example embodiment can be realized. In this case, the processor of the computer performs processing to function as the estimating unit 11, the approximating unit 12, the generating unit 13, the control unit 14, and the optimizing unit 15.

Also, the program according to the second example embodiment may be executed by a computer system constructed by a plurality of computers. In this case, for example, each computer may function as any of the estimating unit 11, the approximating unit 12, the generating unit 13, the control unit 14, and the optimizing unit 15.

### Third Example Embodiment

Although the method described in the second example embodiment is versatile, there are cases where iterative computation is difficult. As one example, iterative computation is difficult when it is necessary to set the movement region quickly or when the computing power of the information processing apparatus is extremely low.

In a third example embodiment, a method for calculating the movement region with less computation than in the second example embodiment is described.

In this third example embodiment, the communication range is not approximated to a non-convex polygon. That is, the approximating unit 12 according to the third example embodiment always approximates to a convex polygon.

To generate a convex polygon approximation, as one example, the algorithm described in Deits, Robin and Russ Tedrake “Computing Large Convex Regions of Obstacle-Free Space Through Semidefinite Programming.” WAFR (2014) can be used. By using this algorithm, it is possible to obtain a close-to-maximum convex polygon that remains within the actual communication range.

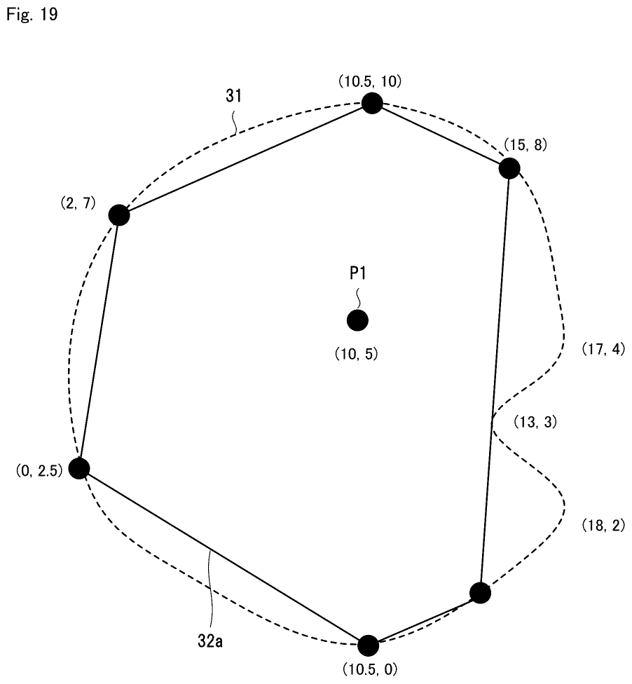

FIG. 19 is a diagram illustrating approximation according to the third example embodiment. In the example in FIG. 19, the communication range 32 is approximated to a convex polygon 32a.

The optimizing unit 15 according to the third example embodiment rotates the approximated convex polygon by 180 degrees around the position of the mobile entity 20 itself, generates a similar convex polygon from the rotated convex polygon based on a reduction ratio s that is set in advance for the movement region, and sets this similar convex polygon as the movement region. A “similar convex polygon” is a figure obtained by changing only the size of the convex polygon.

The reduction ratio for the movement region is s times (where s is a number between 0 and 1). As a conceivable example, the reduction ratio may be 0.4.

The optimizing unit 15 according to the third example embodiment also generates a similar convex polygon from the approximated convex polygon based on a reduction ratio (1-s) for the constant communication region which is set in advance with the position of the mobile entity 20 itself as the center, and sets the resulting polygon as the constant communication region.

The reduction ratio for the constant communication region is (1-s) times (where s is a number between 0 and 1). As a conceivable example, the reduction ratio may be 0.4.

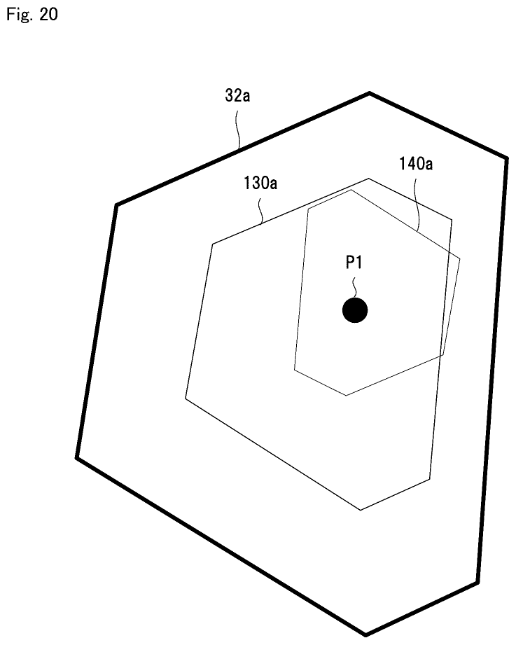

FIG. 20 is a diagram illustrating the movement region and the constant communication region in the third example embodiment. FIG. 20 depicts an example of the relationship between the movement region 140a and the constant communication region 130a based on the approximated convex polygon 32a.

### [Effects of Third Example Embodiment]

As described above, according to the third example embodiment, by using an approximated convex polygon, the movement region and the constant communication region can be easily found in a simple manner.

In addition, this method can also be used to find the optimal movement region. In more detail, an optimization problem can be solved using the reduction ratio (scale) s and coordinates representing the center of the movement region as variables. As one example, Equation 2 can be used as an objective function.

Since the only variables are the reduction ratio and the center coordinates, this optimization problem can be easily solved. It is possible to find the optimal movement region in a single calculation without the need to perform iterated calculations like in the second example embodiment.

Note that with regard to three dimensions, similar processing to the processing described above can be realized using a convex polyhedron.

### [Physical Configuration]

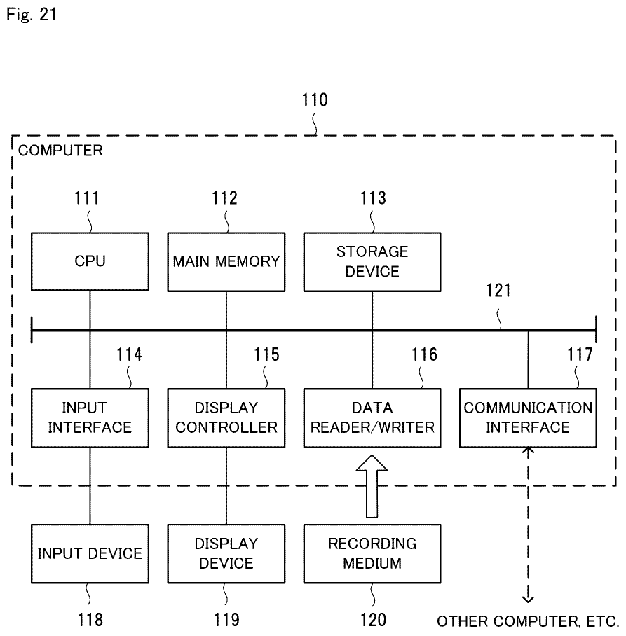

Here, a computer that realizes the information processing apparatus by executing the program according to the first example embodiment, the first example, the second example, the second example embodiment, and the third example embodiment will be described with reference to FIG. 21. FIG. 21 is a diagram illustrating an example of a computer that realizes the first example embodiment, the first example, the second example, the second example embodiment and the third example embodiment.

As shown in FIG. 21, a computer 110 includes a CPU (Central Processing Unit) 111, a main memory 112, a storage device 113, an input interface 114, a display controller 115, a data reader/writer 116, and a communications interface 117. These units are each connected so as to be capable of performing data communications with each other through a bus 121.

Also, the computer 110 may include a GPU (Graphics Processing Unit) or an FPGA (Field-Programmable Gate Array) in addition to the CPU 111 or in place of the CPU 111. In this aspect, a GPU or FPGA can execute the program in this example embodiment.

The CPU 111 opens the program (code) according to this example embodiment, which has been stored in the storage device 113, in the main memory 112 and performs various operations by executing the program in a predetermined order. The main memory 112 is typically a volatile storage device such as a DRAM (Dynamic Random Access Memory).

Also, the program according to this example embodiment is provided in a state being stored in a computer-readable recording medium 120. Note that the program according to this example embodiment may be distributed on the Internet, which is connected through the communications interface 117.

Also, other than a hard disk drive, a semiconductor storage device such as a flash memory can be given as a specific example of the storage device 113. The input interface 114 mediates data transmission between the CPU 111 and an input device 118, which may be a keyboard or mouse. The display controller 115 is connected to a display device 119, and controls display on the display device 119.

The data reader/writer 116 mediates data transmission between the CPU 111 and the recording medium 120, and executes reading of a program from the recording medium 120 and writing of processing results in the computer 110 to the recording medium 120. The communications interface 117 mediates data transmission between the CPU 111 and other computers.

Also, general-purpose semiconductor storage devices such as CF (Compact Flash (registered trademark)) and SD (Secure Digital), a magnetic recording medium such as a Flexible Disk, or an optical recording medium such as a CD-ROM (Compact Disk Read-Only Memory) can be given as specific examples of the recording medium 120.

Also, instead of a computer in which a program is installed, the information processing apparatus according to the first example embodiment, the first example, the second example, the second example embodiment, and the third example embodiment can also be realized by using hardware corresponding to each unit. Furthermore, a portion of the information processing apparatus may be realized by a program, and the remaining portion realized by hardware.

Although the present invention of this application has been described with reference to the first example embodiment, the first example, the second example, the second example embodiment, and the third example embodiment, the present invention of this application is not limited to the above the first example embodiment, the first example, the second example, the second example embodiment, and the third example embodiment. Within the scope of the present invention of this application, various changes that can be understood by those skilled in the art can be made to the configuration and details of the first example embodiment, the first example, the second example, the second example embodiment, and the third example embodiment.

### INDUSTRIAL APPLICABILITY

According to the above description, a framework for maintaining communication between mobile entities is provided. This is useful in fields where mobile entities are used in a multi-agent system.

### REFERENCE SIGNS LIST

1, 1a System
10 Information processing apparatus
11 Estimating unit
12 Approximating unit
13 Generating unit
14 Control unit
15 Optimizing unit
20, 20a, 2b mobile entity
21 Communication unit
22 Sensor unit
23 Moving unit
110 Computer
111 CPU
112 Main memory
113 Storage device
114 Input interface
115 Display controller
116 Data reader/writer
117 Communications interface
118 Input device
119 Display device
120 Recording medium
121 Bus

What is claimed is:

1. An information processing apparatus comprising:
at least one memory storing instructions; and
at least one processor configured to execute the instructions to:
estimate a communication range of a first mobile entity;
generate information representing a boundary of the communication range; and
generate a region where a plurality of points, which are included in a first movement region that has been set in advance for the first mobile entity, and a communication range of the first mobile entity at each of the plurality of points overlap.

2. The information processing apparatus according to claim 1,
wherein the one or more processors further:
generates polygon information representing a polygon that approximates a boundary line of the estimated communication range, and
calculates an overlapping region of a plurality of polygons using a plurality of points included in the first movement region set in advance for the first mobile entity and polygons corresponding to the plurality of points, and generates constant communication region information representing a constant communication region, where the first mobile entity and a second mobile entity are capable of constant communication, to be set as a second movement region of the second mobile entity.

3. The information processing apparatus according to claim 2,
wherein the one or more processors further:
complements the polygons, which are not convex polygons, with supplementary convex polygons to convert the polygons which are not convex polygons to complementary convex polygons.

4. The information processing apparatus according to claim 3,
wherein the one or more processors further:
calculates, using a plurality of points included in the first movement region and the complemented convex polygons corresponding to the plurality of points, the constant communication region which is a region where all of the complemented convex polygons overlap.

5. The information processing apparatus according to claim 3,
wherein the one or more processors further:
calculates, using a plurality of points included in the first movement region and the complemented convex polygons corresponding to the plurality of points, a region where all of the complemented convex polygons overlap, and generates a modified region representing a convex hull using vertices of the supplementary convex polygons included in all of the complemented convex polygons, and
calculates the constant communication region by removing regions that overlap the modified region from a region where all of the complemented convex polygons overlap.

6. The information processing apparatus according to claim 2,
wherein the one or more processors further:
generates a small displacement region using a current first movement region set for the first mobile entity, the current first movement region, a current first constant communication region, a current second movement region set for the second mobile entity, and the current second movement region,
using the generated small displacement region to expand the current first movement region and generate a new first movement region and to reduce the current first constant communication region and generate a new first constant communication region,
using the generated small displacement region to expand the current second movement region and generate a new second movement region and to reduce the current second constant communication region and generate a new second constant communication region, and
determine whether the new first movement region and the new second movement region are optimized.

7. The information processing apparatus according to claim 6,
wherein the one or more processors further:
determines whether the new first movement region and the new second movement region have been optimized based on an increase in area of the new first movement region and an increase in area of the new second movement region.

8. The information processing apparatus according to claim 2,
wherein the one or more processors further:
generates a convex polygon that approximates a boundary line of an estimated communication range and
rotates the approximated convex polygon by 180 degrees around a position of the first mobile entity, generates, from the rotated convex polygon, a similar convex polygon based on a reduction ratio for a movement region which has been set in advance, and sets the similar convex polygon as a movement region.

9. The information processing apparatus according to claim 8,
wherein the one or more processors further:
generates, based on the approximated convex polygon and a reduction ratio for a constant communication region set in advance, a similar convex polygon that is centered on a position of the first mobile entity, and sets the similar convex polygon as the constant communication region.

10. A control method comprising a computer:
estimating a communication range of a first mobile entity;
generating information representing a boundary of the communication range; and
generating a region where a plurality of points, which are included in a first movement region that has been set in advance for the first mobile entity, and a communication range of the first mobile entity at each of the plurality of points overlap.

11. A non-transitory computer readable recording medium that includes a program recorded thereon, the program including instructions that causes a computer to carry out:
estimating a communication range of a first mobile entity;
generating information representing a boundary of the communication range; and
generating a region where a plurality of points, which are included in a first movement region that has been set in advance for the first mobile entity, and a communication range of the first mobile entity at each of the plurality of points overlap.
